(19) United States
(12) Patent Application Publication
(10) Pub. No.: US 2009/0002823 A1
(43) Pub. Date: Jan. 1, 2009

(54) Permanently-Affixed Lens Cap

(76) Inventors: David Law, Seattle, WA (US); Graeme Esarey, Seattle, WA (US); Johannes Refskund Busck, Soeborg (DK)

Correspondence Address: MAXVALUEIP CONSULTING, 11204 ALBERMYRTLE ROAD, POTOMAC, MD, 20854, US

(21) Appl. No.: 11/772,214

(22) Filed: Jun. 30, 2007

(51) Int. Cl. G03B 17/56

(52) U.S. Cl. 359/511; 396/448

(57) ABSTRACT

A permanently-affixed lens cap is presented here. This is a lens cap which one does not have to separate from the camera, to use the camera. Unlike the existing lens caps which clip on the front, and are then removed, these caps remain on the front of the lens practically at all the times. Thus, they do not get lost, and the camera/lens is much safer because of it. Some of the features are: Crystal Clear: a Lens cover which looks like a filter, in that it screws into the filter thread at the end of the lens. This protects the expensive lens from impact and scratches. As an option, the user never has to remove it. Nano-Technology coating: Two separate layers of fine silica particles prevent scratches, and fluorine-containing resins in each layer repel ink marks. This has been used for DVD protection in the industry. Bullet-Proof: Layers of glass and (clear) plastic sandwiched to give great optical clarity, but an incredibly impact resistant front. Non-clear lens, which is permanently attached. The lens cap has a mechanism to flip out of the way. Press a button and the lens cap expands to become a shade, and exposes the front of the lens. Many other variations and extensions are also discussed in the specification and figures.

### RELATED APPLICATIONS

This application is related to the following co-pending applications, with some common inventors, and same exact assignee: (The teaching of all the applications below are incorporated herein by reference.)

U.S. application Ser. No. 11/695,625, filed 4-3-07.

U.S. application Ser. No. 11/696,740, filed 4-5-07.

U.S. application Ser. No. 11/695,624, filed 4-3-07.

### BACKGROUND

The cameras or video recorders, especially expensive cameras, need protection against impact, heat, sun, dirt, moisture, and water. Thus, lens cap is a very important feature on the cameras or video recorders, to protect the lens, which is very expensive and sensitive to scratch and dirt. Some of the related prior art are listed here:
Flora, U.S. Pat. No. 6,971,754, teaches: Lens cap retention arrangement: Vision enhancing apparatus includes a lens and tethered lens cap which protects the lens when the apparatus is not in use. The apparatus also includes a protrusion having a shape complementary to the lens cap for retaining the latter when the apparatus is in use.
Steiner, U.S. Pat. No. 6,799,854, teaches: A pair of binoculars, a telescope or the like, comprising a protective lens cap articulated to the front of the lens, is characterized in that a pivot joint arrangement is formed between an edge of the lens and the protective lens cap, in use having a substantially horizontal pivot axis and a substantially vertical pivot axis.
Harms, U.S. Pat. No. 4,641,932, teaches: A protective cover for optical means, such as binocular optical means, having a pair of exposed lens portions which are spaced apart, comprising first and second cover bodies, each having a lens cap portion for being removably secured over a lens portion of the binoculars. Each of the cover bodies has a connecting portion extending from its cap portion. An attachment means is provided for securing the connecting portions of the bodies to the binoculars at a location intermediate its lens portions. The attachment means allows movement of each of the cap portions between a first position proximate to one of the lens portions and a second position away from and intermediate the lens portion of the binoculars. The attachment means urges each of the bodies towards its second position upon being displaced therefrom, so as to avoid interfering with the binoculars when in use.

However, none of the above teaches the features of the current application and invention, as described below.

### SUMMARY

This invention relates to a lens cap, which can always be on the lens. This can apply to cameras, video recorders, or any similar equipment for similar purposes, with a lens, which needs protection from scratch and dirt. This, for example, applies to projection TVs or slide projectors for presentations, which may or may not get attached to the laptop or computer.

To customize for one model/specific lens or camera, the diameter and thickness are fixed and predetermined. However, to make that flexible for different models, within a range of dimensions, one can use a cap which resembles a cone with its tip cut-off, as a flat surface, parallel to its base plane. That is, it looks like a partial cone, with 2 circular parallel planes on top and bottom sides, in which the top circle has a smaller radius. That is, the diameter is gradually increasing from top circle to bottom circle, covering the whole range between top and bottom circles, making it adaptive and flexible for different camera and lens sizes/diameters/radiuses.

Another way of adjusting to different size lenses is to adjust the outer frame for the cap, in which some flexible or foldable material or structure is used, to fold or to reduce the size of the frame/frame thickness. One example is to use partial or full circles of different sizes that can slide on each other, within a larger frame, to define and set the size of the frame. Whenever the circles, partial circles, or curves are close to each other, e.g. concentric circles, the size is smaller, and the further they get away from each other, the size is bigger, for the frame, to fit a bigger camera/lens diameter.

### BRIEF DESCRIPTION OF THE DRAWINGS

FIG. 1 shows a permanently-affixed lens cap. In one embodiment, the lens cap is optically clear, and attaches to the filter threads on the lens.

FIG. 2 shows a hard clear material, e.g. ALON, Aluminum Oxynitrile.

FIG. 3 shows the cap segments folded to form protective layer.

FIG. 4 shows the removable plastic or metal piece (or reversible), which can hook up or connected to the lens armor at the end of the lens, for example.

FIG. 5 shows the extended lens protection for the body of the lens.

FIG. 6 shows a multi-positioned lens cap armor, and how it may get connected to the rest of the assembly, as an example or embodiment.

FIG. 7 shows all one piece, rubber lens cap, which can be pulled back to reveal the lens partially or fully, as an embodiment.

FIG. 8 is another example or variation of FIG. 7.

FIG. 9 is yet another example or variation of FIG. 7.

### DETAILED DESCRIPTION OF THE PREFERRED EMBODIMENTS

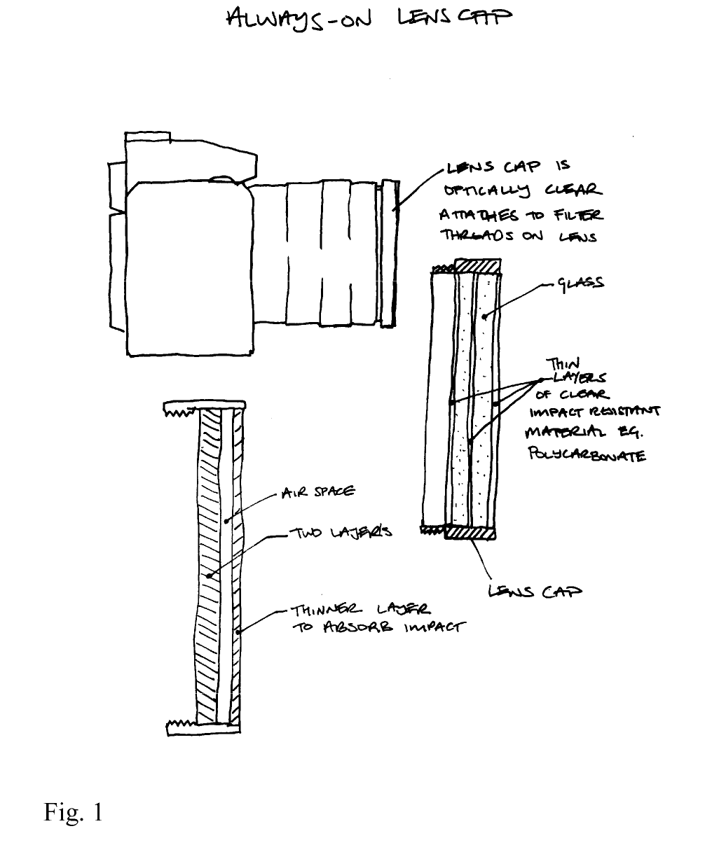

FIG. 1 shows a permanently-affixed lens cap. In one embodiment, the lens cap is optically clear, and attaches to the filter threads on the lens. In one embodiment, it is made of glass. In one embodiment, it is a synthetic material, such as plastic. In one embodiment, it is layers of impact resistant material, such as polycarbonate. In one embodiment, it is a crystal, polycrystalline material, or amorphous material. In one embodiment, it is transparent, translucent, or clear material. In one embodiment, it is clear for visible light range. In one embodiment, it is clear for ultraviolet or invisible electromagnetic radiation.

In one embodiment, it is a bullet-proof/tough material. In one embodiment, it has multiple layers for better impact resistant. In one embodiment, it has air or other gasses between layers. In one embodiment, it has a scratch resistant coating. In one embodiment, it has a sacrificial layer. In one embodiment, the thin layer is shock absorbent layer. In one embodiment, it is one or more gaps between layers. In one embodiment, it has a daylight filter. In one embodiment, it acts as a lens cap. In one embodiment, it is an opaque material, blocking the light. In one embodiment, it has multiple caps with different properties, exchangeable for the same lens.

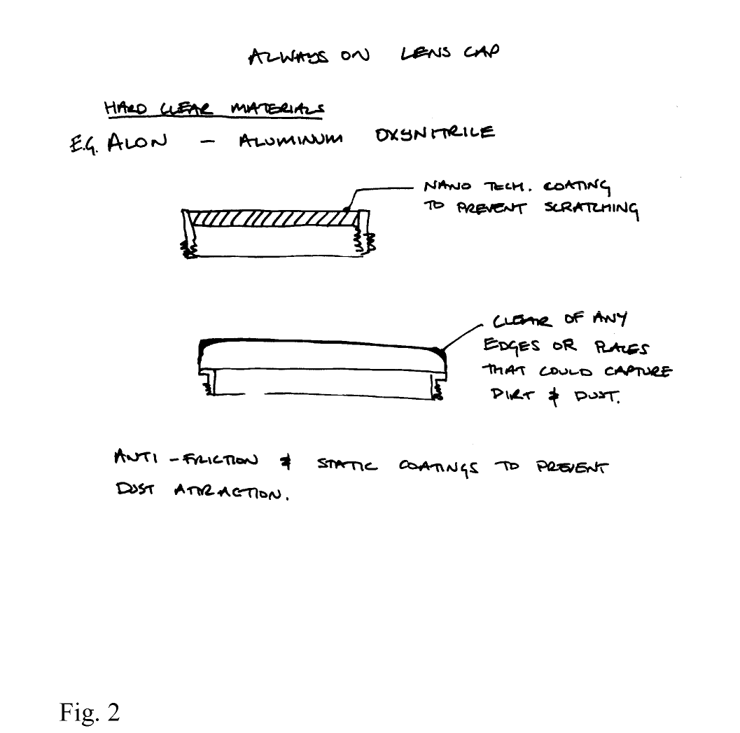

FIG. 2 shows a hard clear material, e.g. ALON, Aluminum Oxynitrile. This is a strong and optically clear material. However, it is more expensive than other choices. In one embodiment, it has a nano-tech coating, to prevent scratch or dust, or similar to the surface of DVD. In one embodiment, the edges are curved to avoid corners that can collect dusts, especially around our lens. In one embodiment, it is an anti-friction and anti-static coatings to prevent dust attraction. In one embodiment, the seams and edges are removed for less dust, and ease of cleaning.

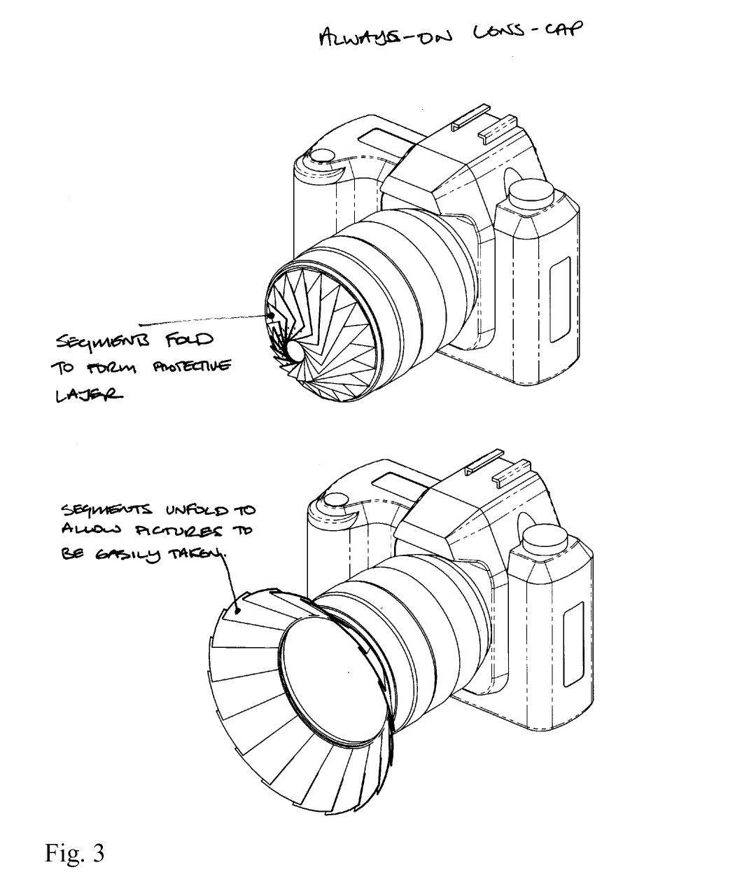

FIG. 3 shows the cap segments folded to form protective layer. In one embodiment, the cap usually stays on camera. In one embodiment, the segments open up to let the light get to the lens, for taking the picture. In one embodiment, the cap is connected to camera, lens, or camera skin, using screw, clamp, threaded lens assembly, tether, leash, or retractable string. In one embodiment, the cap is made of metal, plastic, or synthetic material. In one embodiment, the segments are each 25 percent of a circle, half a circle, a small curved slice of a circle, or moon-shaped segment of a circle or oval. In one embodiment, moving the segments is done by a small motor or by a user. In one embodiment, moving the segments is done automatically, e.g. when a button for taking the picture is pushed or activated.

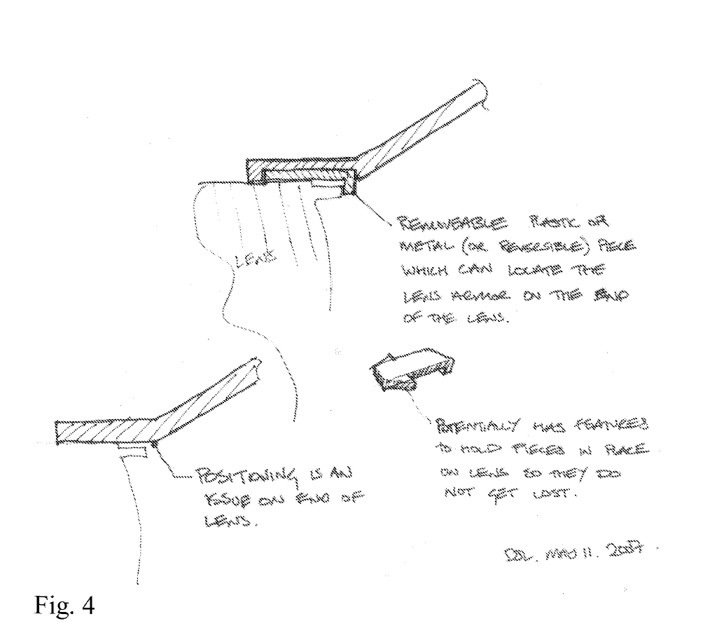

FIG. 4 shows the removable plastic or metal piece (or reversible), which can hook up or connected to the lens armor at the end of the lens, for example. In one embodiment, the piece has a tongue-and-groove structure. In one embodiment, it has a retractable tongue-and-groove structure. In one embodiment, it has a spring-action retractable tongue-and-groove structure.

(Note: This is relevant for our current lens armor, which is the rubber bumper/shade that stretches over the lens, and accommodates many lens sizes. The sketch shows a way to allow the user to position the stretchable lens armor correctly at the tip of the lens, using the reversible features, or alternatively the user can choose not to, and mount the lens armor back, along the body of the lens.)

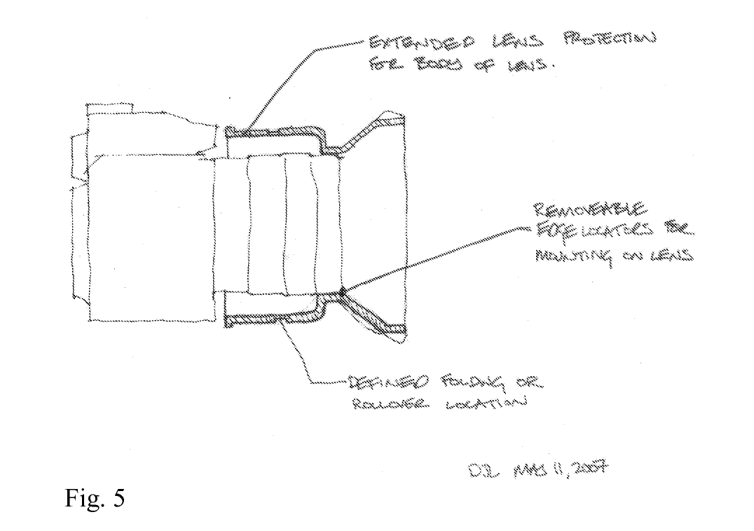

FIG. 5 shows the extended lens protection for the body of the lens. In one embodiment, it has removable edge locators for mounting on the lens. In one embodiment, it has a defined folding or roll-over location.

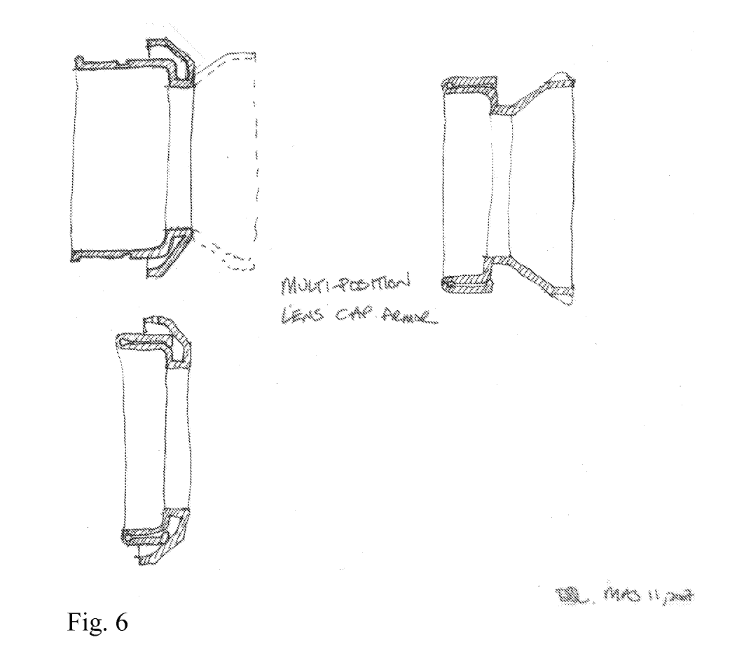

FIG. 6 shows a multi-positioned lens cap armor, and how it may get connected to the rest of the assembly, as an example or embodiment.

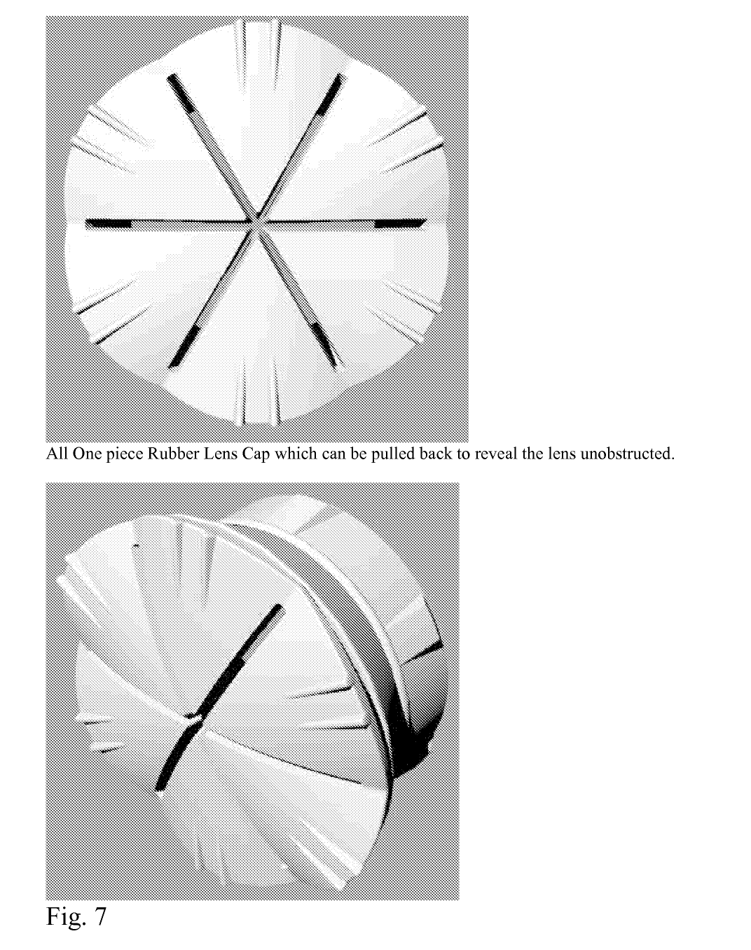

FIG. 7 shows all one piece, rubber lens cap, which can be pulled back to reveal the lens partially or fully, as an embodiment. It can have anti-reflective coating on the shutters or pieces. It can be made of any material, such as plastic or metal.

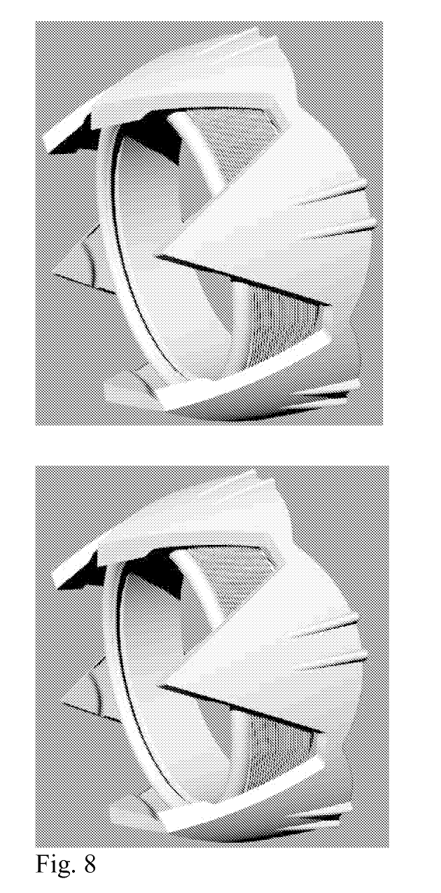

FIG. 8 is another example or variation of FIG. 7.

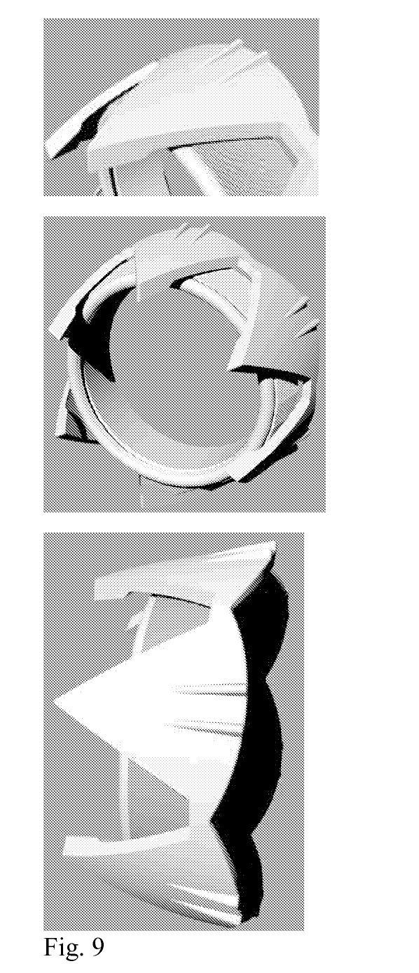

FIG. 9 is yet another example or variation of FIG. 7.

In one embodiment, the frame of the cap is made of one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar, compound, chemical, or composite material.

The lens cap has a material that is clear for certain wavelengths of light or electromagnetic radiation, for both visible and invisible parts of the spectrum.

Any other variation of the above teaching is also meant to be protected by the current patent.

1. A lens cap for a camera, video recorder, or projector,
wherein said lens cap is permanently connected, attached, threaded in, screwed, clamped, secured, or positioned on the said camera, video recorder, projector, lens, lens assembly, or protective skin, and
wherein said lens cap comprises a transparent, clear, or translucent part which lets a light or electromagnetic radiation of a certain wavelengths pass through to the lens, either partially or fully.

2. A lens cap for a camera, video recorder, or projector,
wherein said lens cap is permanently connected, attached, threaded in, screwed, clamped, secured, or positioned on the said camera, video recorder, projector, lens, lens assembly, or protective skin,
wherein said lens cap comprises one or more retractable, movable, foldable, or adjustable parts which, in the open position, lets a light or electromagnetic radiation of a certain wavelengths pass through to the lens, either partially or fully, and
wherein, in the closed position, said lens cap protects the lens against scratch, dust, or other natural elements or phenomenon.

3. A lens cap for a camera, video recorder, or projector, as recited in claim 1, wherein said lens cap is made of multiple layers.

4. A lens cap for a camera, video recorder, or projector, as recited in claim 1, wherein said lens cap is made of multiple layers with gap, air, fluid, or gas in between said multiple layers.

5. A lens cap for a camera, video recorder, or projector, as recited in claim 1, wherein said lens cap is made of one or more of the following material: plastic, glass, quartz, diamond, polycarbonate, single crystal, polycrystal, or amorphous material.

6. A lens cap for a camera, video recorder, or projector, as recited in claim 1, wherein said lens cap is bullet proof, scratch resistant, or dust repellant.

7. A lens cap for a camera, video recorder, or projector, as recited in claim 1, wherein said lens cap has a nano-coating to avoid scratches.

8. A lens cap for a camera, video recorder, or projector, as recited in claim 1, wherein said lens cap has curved edges to avoid dust.

9. A lens cap for a camera, video recorder, or projector, as recited in claim 2, wherein said lens cap is made of multiple parts, wherein said multiple parts are overlapping or covering each other in the closed position.

10. A lens cap for a camera, video recorder, or projector, as recited in claim 9, wherein said multiple parts are spreading out or diverging away from each other in the open position.

11. A lens cap for a camera, video recorder, or projector, as recited in claim 1, wherein said lens cap comprises silica or fluorine compounds or material.

12. A lens cap for a camera, video recorder, or projector, as recited in claim 1, wherein said lens cap acts as a daylight filter, color filter, high-pass filter, or low-pass filter.

13. A lens cap for a camera, video recorder, or projector, as recited in claim 1, wherein said lens cap is adjustable in size, diameter, or shape.

14. A lens cap for a camera, video recorder, or projector, as recited in claim 1, wherein said lens cap has an adjustable or flexible frame, frame thickness, or frame diameter.

15. A lens cap for a camera, video recorder, or projector, as recited in claim 1, wherein said lens cap acts as an optical lens.

16. A lens cap for a camera, video recorder, or projector, as recited in claim 2, wherein said lens cap is operated or controlled by a motor, computer, or processor.

17. A lens cap for a camera, video recorder, or projector, as recited in claim 2, wherein said lens cap is operated by a user.

18. A lens cap for a camera, video recorder, or projector, as recited in claim 2, wherein said lens cap is operated automatically, based on predetermined or preset rules, constraints, or conditions.

19. A lens cap for a camera, video recorder, or projector, as recited in claim 2, wherein said lens cap is coated with an anti-reflective material or coating.

20. A lens cap for a camera, video recorder, or projector, as recited in claim 2, wherein said lens cap is made of or comprises one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar material, compound, chemical, or composite material.
